(19) United States
(12) Patent Application Publication
(10) Pub. No.: US 2010/0149332 A1
(43) Pub. Date: Jun. 17, 2010

(54) REMOTE WIRELESS MONITORING SYSTEM

(76) Inventor: Patrick Shui Chung Wang, Hong Kong (CN)

Correspondence Address: Muncy, Geissler, Olds & Lowe, PLLC, 4000 Legato Road, Suite 310, FAIRFAX, VA, 22033, US

(21) Appl. No.: 12/637,164

(22) Filed: Dec. 14, 2009

(30) Foreign Application Priority Data
Dec. 17, 2008 (CN) 200810241279.7

(51) Int. Cl. H04N 7/18; H04W 4/00

(52) U.S. Cl. 348/143; 348/E07.085; 455/414.1; 340/3.1

(57) ABSTRACT

A remote wireless monitoring system, for monitoring and controlling a number of predetermined objects, includes a mobile terminal and a monitoring device. The mobile terminal comprises an input unit configured to receive commands from a user, a control unit configured to generate control signal in response to the commands, and a first wireless communication unit configured to send out the control signal. The monitoring device comprises a second wireless communication unit configured to cooperate with the first communication unit to transmit wireless signals between the terminal and the monitoring device, an image-capturing unit configured to capture images from the objects, a remote control unit configured to control the objects, a drive unit configured to move or change the orientation of the remote control unit and the image-capturing unit , and a slave control unit configured to control movement of the drive unit such that the drive unit orients the image-capturing unit and the remote control unit towards one of the objects corresponding to the command.

### CROSS REFERENCE TO RELATED APPLICATIONS

This non-provisional patent application claims priority under 35 U.S.C. §119(a) from Patent Application No. 200810241279.7 filed in The People's Republic of China on Dec. 17, 2008.

### FIELD OF THE INVENTION

This invention relates to a monitoring system and in particular, to a remote wireless monitoring system.

### BACKGROUND OF THE INVENTION

Remote monitoring systems have been widely used. For example, video monitoring systems have been widely used in supermarkets and parks. Users can watch a remote area via a terminal. However, many known remote monitoring systems use wire transmission technology which has drawbacks such as complicated wire layout and high cost.

With the development of wireless transmission technology, remote wireless monitoring systems have appeared. However, most known remote monitoring systems can only watch. Users cannot control or interact with objects being watched remotely. Furthermore, many known remote monitoring system use stationary cameras to capture images of the objects. Thus, the viewing aspect of the cameras is limited.

Therefore, it is desired to develop an improved remote wireless monitor system which can solve the above mentioned problems.

### SUMMARY OF THE INVENTION

Hence there is a desire for an improved remote monitoring system which can control objects being monitored.

Accordingly, in one aspect thereof, the present invention provides a remote wireless monitoring system for monitoring and controlling objects, the system comprising: a mobile terminal comprising: an input unit configured to input commands, a control unit configured to generate control signals in response to the commands from the input unit, and a first wireless communication unit configured to send out the control signals; and a monitoring device comprising: a second wireless communication unit configured to cooperate with the first communication unit to transmit wireless signals between the mobile terminal and the monitoring device, an image-capturing unit configured to capture images of the objects, a remote control unit configured to control the objects, a drive unit configured to orient the remote control unit and the image-capturing unit, and a slave control unit configured to control movement of the drive unit such that the drive unit orients the image capture unit and the remote control unit towards a selected one of the objects corresponding to the command.

Preferably, the mobile terminal further comprises a memory unit configured to save information about the location of the objects.

Preferably, the wireless signals are transmitted between the first and second wireless communication units via a 3G, GPRS or CDMA network.

Preferably, the mobile terminal is a mobile phone.

Preferably, the drive unit is capable of driving the remote control unit and the image-capturing unit to move in at least one of a pan direction and a tilt direction.

Preferably, the drive unit is capable of driving the remote control unit and the image-capturing unit to move in a pan direction and a tilt direction.

Preferably, the image-capturing unit comprises a camera with a zoom function.

According to a second aspect, the present invention provides a monitoring device comprising: a wireless communication unit configured to receive/send out wireless signals, an image-capturing unit configured to capture images of predetermined objects, a remote control unit configured to send out remote control signals to the objects, a drive unit configured to move the remote control unit and the image-capturing unit, and a control unit configured to control movement of the drive unit such that the drive unit orients the image capture unit and the remote control unit towards a selected one of the objects.

Preferably, the image-capturing unit comprises a camera mounted to the drive unit and the drive unit is capable of panning and/or tilting the camera.

According to a second aspect, the present invention provides a remote wireless monitoring and control method comprising: sending a control signal via a mobile terminal, receiving the control signal by a monitoring device which comprises a remote control unit and a drive unit, controlling the drive unit to orient the remote control unit towards a object corresponding to the control signal, and sending out a remote control signal from the remote control unit to said object.

Preferably, the monitoring device further comprises an image-capturing unit configured to capture images of the object, and the method further comprises displaying images of the object captured by the image-capturing unit on the mobile terminal.

Preferably, the control signal is a selection signal, and the method further comprises sending an operation signal via the mobile terminal to the monitoring device before the remote control unit sends out the remote control signal.

### BRIEF DESCRIPTION OF THE DRAWINGS

A preferred embodiment of the invention will now be described, by way of example only, with reference to figures of the accompanying drawings, in which:

FIG. 1 is a block diagram of a remote wireless monitoring system in accordance with one embodiment of the present invention; and

FIG. 2 is a flow chart showing how to use the remote wireless monitoring system of FIG. 1.

### DETAILED DESCRIPTION OF THE PREFERRED EMBODIMENTS

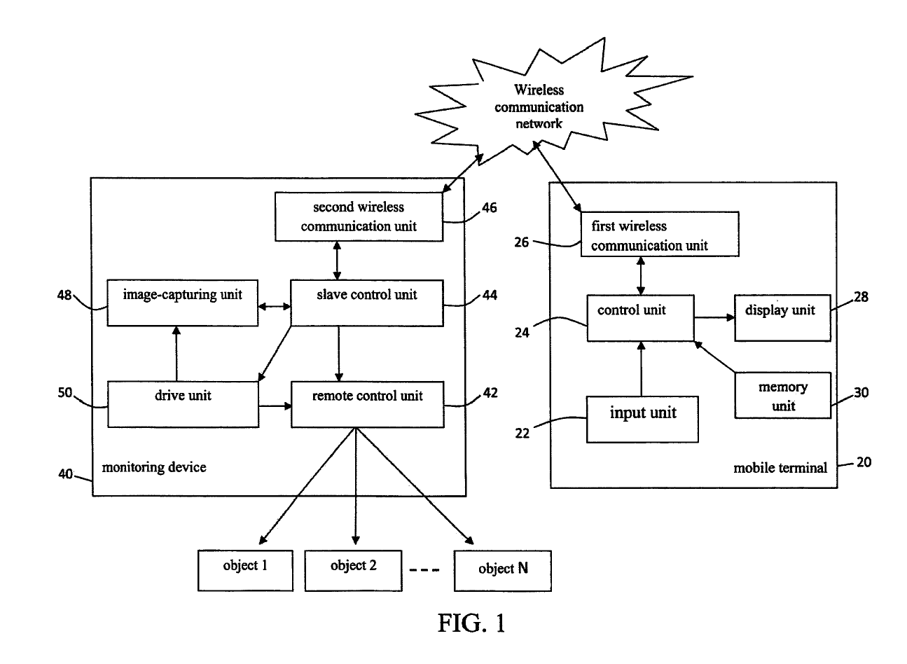

As shown in FIG. 1, a remote wireless monitoring system according to the preferred embodiment of the present invention comprises a mobile terminal 20 and a monitoring device 40.

The mobile terminal 20 has an input unit 22, a control unit 24, a first wireless communication unit 26, a display unit 28 and optionally, a memory unit 30. The input unit 28 is configured to pass commands from a user to the control unit 24. The control unit communicates with the first wireless communication unit 26, and the display unit 28. The control unit 24 is configured to generate control signals in response to the commands from the input unit. The control signals are sent out via the first wireless communication unit. Preferably, the mobile terminal also comprises a memory unit 30 configured to save information about the location of the objects 1˜N being monitored. The display unit displays images of the objects 1˜N.

The monitoring device 40 has a remote control unit 42, slave control unit 44, a second wireless communication unit 46, an image-capturing unit 48 and a drive unit 50. The second wireless communication unit 46 cooperates with the first communication unit 26 to transmit wireless signals between the mobile terminal 20 and the monitoring device 40. The slave control unit 44 communicates with the second wireless communication unit 46 to send signals to and receive signals from the control unit 24 of the mobile terminal 20. The image-capturing unit captures images from the objects being monitored and the remote control unit is configured to control the objects. The drive unit 50 is arranged to drive the remote control unit and the image-capturing unit, under the control of the slave control unit 44. The drive unit moves the remote control unit and the image-capturing unit to orient them towards the object to be monitored and/or controlled as determined by user commands entered via the input unit, to bring up an image of the selected object on the display unit 28.

The image-capturing unit comprises at least one camera installed on the drive unit. Preferably, the drive unit adapts a “omni-directional” platform disclosed in Chinese Patent Application No. 200810141802.9, the content of which is incorporated herein by reference. Thus, the drive unit is capable of panning/tilting the camera in a substantially 4π steradian solid angle of directions under the control of the control unit. Preferably, the camera has a zoom function so that the image of the object can be enlarged or reduced at the option of the user.

Preferably, the remote control unit 42 is mounted on or installed in the drive unit adjacent to the camera. Thus when the camera is oriented towards a selected object, the remote control is also oriented toward the selected object. Preferably, the remote control unit is a universal remote control which has an IC saving codes corresponding to controllable functions of the objects respectively. When the selected object receives a corresponding remote control signal from the remote control unit, the object responds according to the function controlled by the signal, for example, turns on/off.

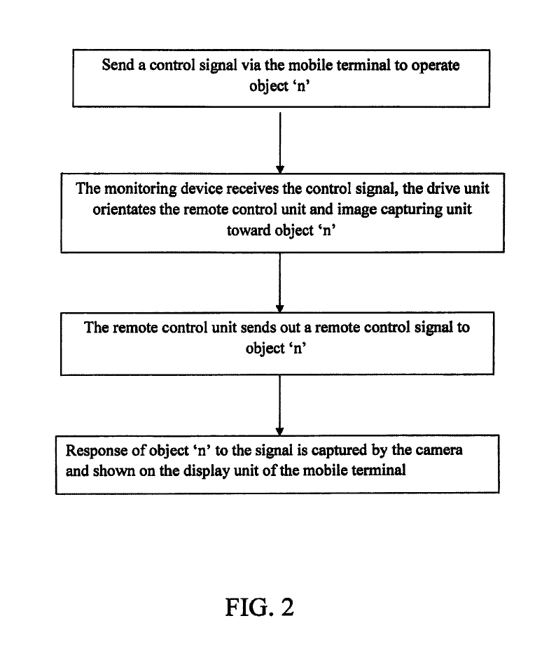

FIG. 2 is a flow chart illustrating a monitoring and control method using the remote wireless monitor system of the present invention. The method comprising the following steps: 1) sending out a control signal via a mobile terminal, 2) receiving the control signal via a monitoring device, 3) moving a camera to view an object selected by the control signal, and 4) operating a remote control unit to operate the selected object in accordance with the control signal.

Specifically, the user inputs a selection command using the input unit 22. The control unit 24 of the mobile terminal generates a corresponding control signal in response to the selection command. The control signal is sent to the monitoring device 40 via the first wireless communication unit 26.

The slave control unit 44 of the monitoring device 40 receives the control signal via the second wireless communication unit 46. The slave control unit instructs the drive unit 50 of the monitoring device to move the remote control unit and the camera to orient towards the object selected by the control signal. Specifically, the second wireless communication unit receives the control signal from the first wireless communication unit and sends it to the slave control unit of the monitoring device which controls movement of the drive unit such that the remote control unit and the image-recapturing device orients towards the object selected by the control signal. The image-capturing unit captures the image of the selected object which is sent to the mobile terminal via the wireless communication network and displayed by the display unit. The user then inputs an operation command via the input unit after he looks at the selected object in the display unit.

Upon receipt of the operation command by the monitoring device, the slave control unit 44, via the remote control unit, sends out a remote control signal towards the selected object. The selected object is thus operated. Understandably, the remote control signal from the remote control unit may be any suitable wireless control signal such as a blue-tooth signal, an infrared signal and so on.

Alternatively, when the remote control unit and the image-capturing unit orient towards the selected object, the control unit of the monitor device may automatically control the remote control to send out the remote control signal to the selected object without needing the user to input the operation command or for the user to wait for the selected object to be in view on the display unit before sending the command signal.

In an alternative embodiment, the memory unit 30 of the mobile terminal 20 may be omitted. After the monitoring device receives the selection signal, the slave control unit 44 of the monitor device may control the drive unit to pan/tilt along a predetermined path until the image-capturing unit orients toward an object which is the object the user wants to operate. When the user looks at the selected object on the display unit, the user may input an operation command via the input unit. When the monitor device receives the operation signal, the slave control unit controls the drive unit to stop movement and controls the remote control unit to send out the remote control signal to the selected object.

The wireless remote monitoring system described above may be used to remotely monitor and control household appliances such as air conditioners, TVs, recorders, refrigerators. For example, a user can input a selection command to select an air condition, via a 3G mobile phone when he is going home. When the wireless communication unit 46 of the monitoring device 40 receives the selection signal, the slave control unit of the monitoring device installed at home controls the drive unit to move the image-capturing unit and the remote control unit to orient towards the air conditioner control panel and controls the remote control unit to send out a remote control signal to the air condition, to thereby turn on/off the air condition, as desired by the user.

Understandably, the wireless remote monitor system described above may also be used to remotely monitor and control other appliances with wireless receivers.

In the description and claims of the present application, each of the verbs “comprise”, “include”, “contain” and “have”, and variations thereof, are used in an inclusive sense, to specify the presence of the stated item but not to exclude the presence of additional items.

Although the invention is described with reference to one or more preferred embodiments, it should be appreciated by those skilled in the art that various modifications are possible. Therefore, the scope of the invention is to be determined by reference to the claims that follow.

1. A remote wireless monitoring system for monitoring and controlling objects, the system comprising:
a mobile terminal comprising:
an input unit configured to input commands,
a control unit configured to generate control signals in response to the commands from the input unit, and
a first wireless communication unit configured to send out the control signals; and
a monitoring device comprising:
a second wireless communication unit configured to cooperate with the first communication unit to transmit wireless signals between the mobile terminal and the monitoring device,
an image-capturing unit configured to capture images of the objects,
a remote control unit configured to control the objects,
a drive unit configured to orient the remote control unit and the image-capturing unit, and
a slave control unit configured to control movement of the drive unit such that the drive unit orients the image capture unit and the remote control unit towards a selected one of the objects corresponding to the command.

2. The system of claim 1, wherein the mobile terminal further comprises a memory unit configured to save information about the location of the objects.

3. The system of claim 1, wherein the wireless signals are transmitted between the first and second wireless communication units via a 3G, GPRS or CDMA network.

4. The system of claim 1, wherein the mobile terminal is a mobile phone.

5. The system of claim 1, wherein the drive unit is capable of driving the remote control unit and the image-capturing unit to move in at least one of a pan direction and a tilt direction.

6. The system of claim 1, wherein the drive unit is capable of driving the remote control unit and the image-capturing unit to move in a pan direction and a tilt direction.

7. The system of claim 1, wherein the image-capturing unit comprises a camera with a zoom function.

8. A monitoring device comprising:
a wireless communication unit configured to receive/send out wireless signals,
an image-capturing unit configured to capture images of predetermined objects,
a remote control unit configured to send out remote control signals to the objects,
a drive unit configured to move the remote control and the image-capturing unit, and
a control unit configured to control movement of the drive unit such that the drive unit orients the image capture unit and the remote control unit towards a selected one of the objects.

9. The monitoring device of claim 8, wherein the image-capturing unit comprises a camera mounted to the drive unit and the drive unit is capable of panning and/or tilting the camera.

10. The monitoring device of claim 8, wherein the image-capturing unit comprises a camera with a zoom function.

11. A remote wireless monitoring and control method comprising:
sending a control signal via a mobile terminal,
receiving the control signal by a monitoring device which comprises a remote control unit and a drive unit, controlling the drive unit to orient the remote control unit towards a object corresponding to the control signal, and
sending out a remote control signal from the remote control unit to said object.

12. The method of claim 11, wherein the monitoring device further comprises an image-capturing unit configured to capture images of the object, and the method further comprises displaying images of the object captured by the image-capturing unit on the mobile terminal.

13. The method of claim 12, wherein the control signal is a selection signal, and the method further comprises sending an operation signal via the mobile terminal to the monitoring device before the remote control unit sends out the remote control signal.
